(19) United States
(12) Patent Application Publication
(10) Pub. No.: US 2014/0304079 A1
(43) Pub. Date: Oct. 9, 2014

(54) CONTENTS AND ADVERTISEMENT PROVIDING METHOD AND CONTENTS PROVISION APPARATUS

(71) Applicant: Daum Communications Corp., Jeju-si (KR)

(72) Inventor: Ji Eun LEE, Seoul (KR)

(21) Appl. No.: 14/245,684

(22) Filed: Apr. 4, 2014

(30) Foreign Application Priority Data
Apr. 9, 2013 (KR) 10-2013-0038832

(51) Int. Cl. G06Q 30/02

(52) U.S. Cl. CPC G06Q 30/0269
USPC 705/14.61; 705/14.4; 705/14.49; 705/14.66

(57) ABSTRACT

Disclosed is a method of providing contents requested by a user and an advertisement through an application by a contents providing apparatus, including: exposing the contents through a user terminal; stopping the exposed contents at a specific time set based on log-in information of the user, and exposing one or more advertisements; and exposing the stopped contents through the user terminal again.

### CROSS-REFERENCE TO RELATED APPLICATIONS

This application claims priority to and the benefit of Korean Patent Application No. 10-2013-0038832 filed in the Korean Intellectual Property Office on Apr. 9, 2013, the entire contents of which are incorporated herein by reference.

### TECHNICAL FIELD

The present invention relates to a contents and advertisement providing method, and a contents providing apparatus, and more particularly, to a contents and advertisement providing method of providing contents and an advertisement, and a contents providing apparatus using log-in information of a user.

### BACKGROUND ART

In the related art, as the number of users using the Internet has increased, it is common to use an advertisement method of exposing an advertisement on an Internet site is prevalent. However, recently, the more common a portable terminal becomes available, such as a tablet PC, a net book computer, and a smart phone, the number of users of the Internet using the terminals is exponentially increased.

In the related art, a user uses an Internet site through a large monitor screen of a computer, so that the exposure of an advertisement is not much limited. However, recently, the user using the Internet through the portable terminal is increased, but a screen of the portable terminal is small, so that there is a limit in utilizing a space for exposing an advertisement due to the small screen.

A typical method of exposing an advertisement through the portable terminal includes a method of exposing an advertisement in a form of a banner at an upper end or a lower end of a screen, or a method of displaying a new screen on an original screen in a pop-up form and exposing an advertisement.

However, according to the method, in a case where the number of elements of information or contents to be exposed is large, it is not easy to configure and expose an advertisement in accordance with a size of a screen. Further, when users use a web page, contents, and the like, an advertisement is exposed in a form of a banner or a pop-up, so that the users may be hindered in using an Internet service, contents, or the like which the user desires to receive. For example, when the advertisement is exposed in the pop-up form, the user needs to delete a pop-up window and the like in order to use originally used contents, so that it may be very cumbersome and inconvenient for the users. The exposure of the advertisement in the pop-up form has a high possibility in that the advertisement is not an image expected by the user, so that it may impact the user by recognizing the advertisement in a negative aspect while visually impairing the screen.

### SUMMARY OF THE INVENTION

The present invention has been made in an effort to provide contents and an advertisement by using log-in information of a user.

An exemplary embodiment of the present invention provides a method of providing contents requested by a user and an advertisement through an application by a contents providing apparatus, the method including: exposing the contents through a user terminal; stopping the exposed contents at a specific time set based on log-in information of the user, and exposing one or more advertisements; and exposing the stopped contents through the user terminal again.

In the exemplary embodiment of the present invention, the exposing of the one or more advertisements may include: calculating an average application use time of the user based on the log-in information, and setting the calculated average use time as a duration threshold; calculating the average number of pages consumed for the average use time based on the log-in information, and setting the calculated average number of pages as the unit number of pages; and setting the specific time based on at least one of the duration threshold and the unit number of pages.

In the exemplary embodiment of the present invention, the exposing of the one or more advertisements may include randomly setting the specific time within the duration threshold, and exposing the one or more advertisements within a range of the unit number of pages.

In the exemplary embodiment of the present invention, the setting of the specific time may include setting a time right after elapse of the duration threshold as the specific time when there is no movement of a page by the user in the duration threshold.

In the exemplary embodiment of the present invention, the exposing of the one or more advertisements may include setting the one or more advertisements to be exposed based on at least one of personal information about the user and information related to the contents exposed in the duration threshold.

In the exemplary embodiment of the present invention, the exposing of the one or more advertisements may include setting one or more advertisements to be exposed at a specific time set in a second duration threshold based on information related to contents exposed in a first duration threshold.

In the exemplary embodiment of the present invention, the exposing of the one or more advertisements may include setting a predetermined reference time the specific time or randomly setting the specific time when the user does not log in.

In the exemplary embodiment of the present invention, the exposing of the one or more advertisements may include sequentially exposing each of the exposed advertisements according to order information when the one or more advertisements include order information, and a number of specific times at which the one or more advertisements are exposed is plural.

Another exemplary embodiment of the present invention provides a contents providing apparatus for providing contents requested by a user and an advertisement through an application, the apparatus including: a contents exposing unit configured to expose exposing the contents through a user terminal; an advertisement exposing unit configured to stop the exposed contents at a specific time set based on log-in information of the user, and expose one or more advertisements; and a contents re-exposing unit configured to expose the stopped contents through the user terminal again.

In the exemplary embodiment of the present invention, the advertisement exposing unit may set an average application use time of the user calculated based on the log-in information as a duration threshold, calculate the average number of pages consumed for the average use time and set the calculated average number of pages as the unit number of pages, and set the specific time based on at least one of the duration threshold and the unit number of pages.

In the exemplary embodiment of the present invention, the advertisement exposing unit may randomly set the specific time within the duration threshold, and exposes the one or more advertisements within a range of the unit number of pages.

In the exemplary embodiment of the present invention, the advertisement exposing unit may set a time right after elapse of the duration threshold as the specific time when there is no movement of a page by the user in the duration threshold.

In the exemplary embodiment of the present invention, the advertisement exposing unit may further include an advertisement setting unit configured to set the one or more advertisements to be exposed based on at least one of personal information about the user and information related to the contents exposed in the duration threshold.

In the exemplary embodiment of the present invention, the advertisement setting unit may set the one or more advertisements to be exposed at a specific time set in a second duration threshold based on information related to contents exposed in a first duration threshold.

In the exemplary embodiment of the present invention, the advertisement exposing unit may set a predetermined reference time as the specific time or randomly set the specific time when the user does not log in.

In the exemplary embodiment of the present invention, the advertisement exposing unit may sequentially expose each of the exposed advertisements according to order information when the one or more advertisements include the order information, and a number of specific times, at which the one or more advertisements are exposed, is plural.

According to the exemplary embodiments of the present invention, it is possible to improve an effect of an advertisement by exposing the advertisement in the middle of provision of contents by using log-in information of a user. Further, it is possible to expose an advertisement, to which interest of a user is reflected, by setting the advertisement to be exposed based on information related to contents consumed by the user.

It should be understood that the effects of the present invention are not limited to the aforementioned effects, and include all of the effects deducible from the detailed description of the present invention or the configuration of the invention described in the claims.

### BRIEF DESCRIPTION OF THE DRAWINGS

FIG. 1 is a schematic diagram illustrating a contents providing apparatus according to an exemplary embodiment of the present invention.

FIG. 2 is a diagram illustrating a configuration of a contents providing apparatus according to the exemplary embodiment of the present invention.

FIG. 3 is a diagram illustrating an example for setting a specific time according to the exemplary embodiment of the present invention.

FIG. 4 is a flowchart illustrating a contents and advertisement providing method according to an exemplary embodiment of the present invention.

### DETAILED DESCRIPTION

Hereinafter, the present invention will be described with reference to the accompanying drawings. However, the present invention may be implemented in various different ways, so that the present invention is not limited to the exemplary embodiment described herein. A part irrelevant to the description will be omitted in the drawings to clearly describe the present invention, and the same elements will be designated by the same reference numerals throughout the specification.

Throughout this specification and the claims that follow, when it is described that an element is “coupled” to another element, the element may be “directly coupled” to the other element or “indirectly coupled” to the other element through a third element. In addition, unless explicitly described to the contrary, the word “comprise” and variations such as “comprises” or “comprising”, will be understood to imply the inclusion of stated elements but not the exclusion of any other elements.

Hereinafter, an exemplary embodiment of the present invention will be described in detail with reference to the accompanying drawing.

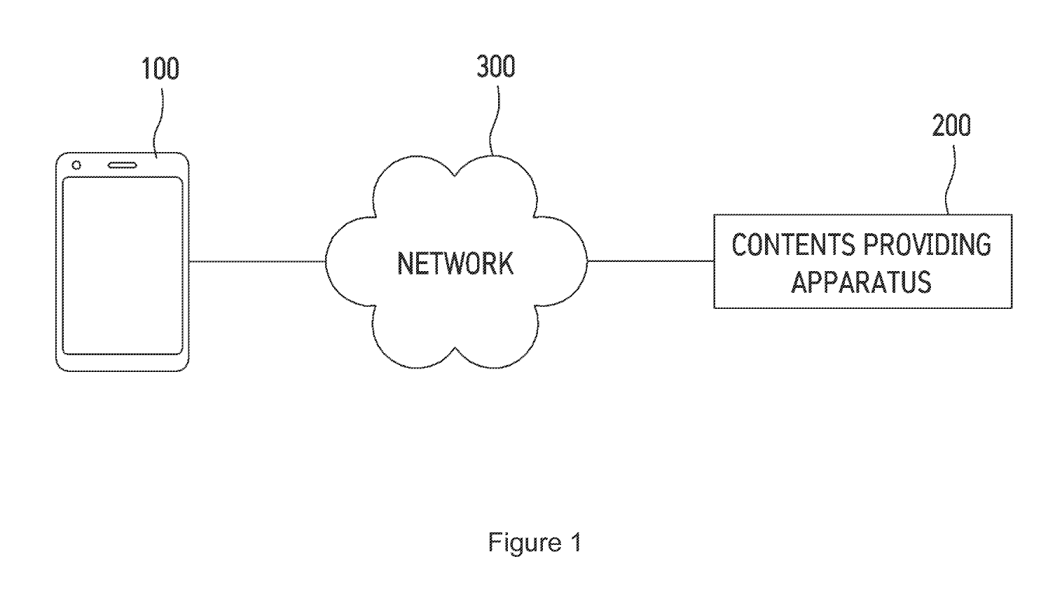

FIG. 1 is a schematic diagram illustrating a contents providing apparatus according to an exemplary embodiment of the present invention.

Referring to FIG. 1, the contents providing apparatus according to an exemplary embodiment of the present invention includes a user terminal 100 and a contents providing apparatus 200. In this case, the user terminal 100 and the contents providing apparatus 200 may be connected through a network 300.

An application for exposing one or more of contents and an advertisement may be installed in the user terminal 100, and contents and an advertisement requested by a user may be exposed through the installed application.

The user terminal 100 may include all types of handheld-based wireless communication devices including a portable terminal including a communication function, such as a Personal Communication System (PCS), Global System for Mobile communications (GSM), a Personal Digital Cellular (PDC) terminal, a Personal Handyphone System (PHS), a Personal Digital Assistant (PDA), an International Mobile Telecommunication (IMT)-2000 terminal, a Code Division Multiple Access (CDMA)-2000 terminal, a W-Code Division Multiple Access (W-CDMA) terminal, a Wireless Broadband Internet (Wibro) terminal, a Personal Digital Assistant (PDA), and a smart phone, a computer, such as a hand-held PC, a notebook computer, a lap top computer, and a desk top computer, and a portable terminal, such as an MP3 player and an MD player.

The contents providing apparatus 200 exposes contents and an advertisement through the application installed in the user terminal 100. In this case, the contents providing apparatus 200 may receive an advertisement from an advertisement server (not illustrated), an advertiser terminal (not illustrated), or the like, but is not limited thereto.

Particularly, the contents providing apparatus 200 exposes contents requested by the user through the user terminal 100, and stops the currently exposed contents at a predetermined specific time based on log-in information of the user, and exposes one or more advertisements.

In this case, the contents providing apparatus 200 may store information about the exposed contents or the exposed and stopped contents. For example, the information about the contents may include identification information about the contents, information about an exposed page of the contents, information about a stopped page, information about a time at which the contents are stopped, identification information about the user terminal, and the like. Accordingly, when the contents are exposed again after the advertisement is exposed, the contents may be exposed from the stopped page of the corresponding contents again, and one or more advertisements, to which interest of the user is reflected, may be set to be exposed based on the information about the contents.

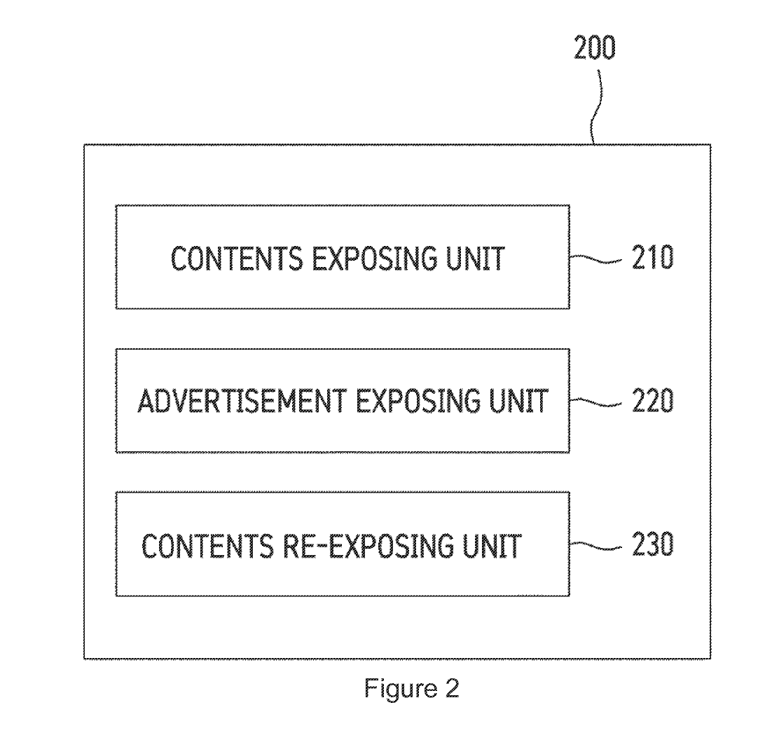

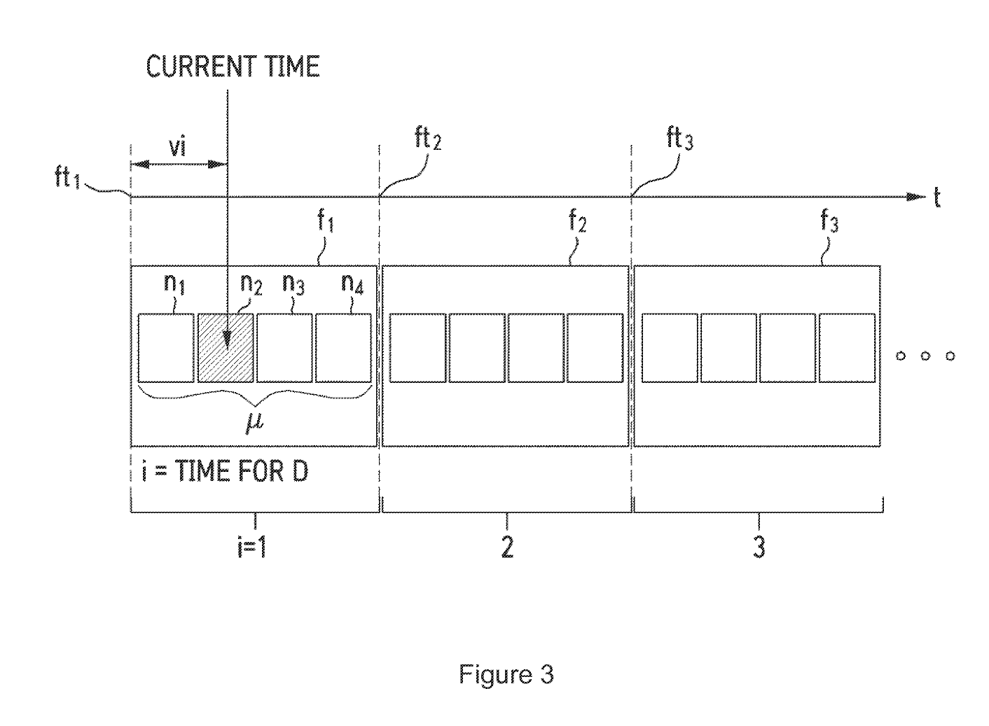

The contents providing apparatus 200 may calculate an average use time of the application of the user based on the log-in information of the user, and calculate the average number of pages consumed for the average use time. Further, the contents providing apparatus 200 may set the calculated average use time as a duration threshold (i.e., unit time duration), set the average number of pages consumed for the calculated average use time as the unit number of pages, and set a specific time based on one or more of the set duration threshold and the unit number of pages. This will be described with reference to FIGS. 2 and 3 below.

Here, the number of pages consumed means the number of pages used by the user among pages including contents displayed to the user through the application, that is, the number of pages read or used by the user when the contents displayed through a screen of the user terminal 100 is formed of a plurality of pages. For example, when the user views an e-book through the user terminal 100, the number of pages thumbed through by the user according to the read of the e-book by the user may be the number of pages consumed.

The contents providing apparatus 200 may set one or more advertisements to be exposed based on at least one of personal information about the user and information about the contents exposed in the duration threshold. Here, the personal information about the user may include a gender, an age, a location, and the like of the user, but is not limited thereto.

After the exposure of the advertisement at the specific time, the contents providing apparatus 200 exposes the stopped contents through the user terminal 100 again. In this case, the contents providing apparatus 200 may expose a stopped page of the corresponding contents based on the information related to the stopped contents stored when the contents are stopped.

In the meantime, when one or more advertisements includes order information, and a number of specific times, at which the one or more advertisements are exposed, is plural, the contents providing apparatus 200 may make each of the exposed advertisements be sequentially exposed according to the order information. This will be described below with reference to FIG. 3.

The network 300 may be implemented with a wired network, such as a local area network (LAN), a wide area network (WAN), or a value added network (VAN), or all types of wireless network, such as a mobile radio communication network or a satellite communication network.

FIG. 2 is a diagram illustrating a configuration of the contents providing apparatus according to the exemplary embodiment of the present invention.

Referring to FIG. 2, the contents providing apparatus 200 according to the exemplary embodiment of the present invention includes a contents exposing unit 210, an advertisement exposing unit 220, and a contents re-exposing unit 230.

The contents exposing unit 210 exposes contents requested by the user through the user terminal 100 (see FIG. 1).

The advertisement exposing unit 220 stops contents, which are being exposed at the predetermined specific time, based on the log-in information of the user, and exposes one or more advertisements. In this case, the advertisement exposing unit 220 may store information related to the stopped contents.

When the user logs in, the advertisement exposing unit 220 may calculate an average application use time of the user based on the log-in information of the user, and set the calculated average use time as a duration threshold. Further, the advertisement exposing unit 220 may calculate the average number of pages consumed for the average use time based on the log-in information of the user, and set the calculated average number of pages as the unit number of pages. Further, the advertisement exposing unit 220 may set the specific time based on at least one of the duration threshold and the unit number of pages.

The advertisement exposing unit 220 may randomly set the specific time within the duration threshold, and expose one or more advertisements within a range of the unit number of pages. In this case, when a movement of the page by the user is not generated for the duration threshold, the advertisement exposing unit 220 may set a time right after the elapse of the duration threshold as the specific time.

In the meantime, the one or more exposed advertisements may include the order information. In this case, the advertisement exposing unit 220 may expose the one or more advertisements, and may control each of the one or more advertisements to be sequentially exposed according to the order information. However, the exposure of the one or more advertisements is not limited thereto, and the one or more advertisements may be randomly exposed without an order.

In the meantime, when the user does not log in, that is, there is no log-in information of the user, the advertisement exposing unit 220 set a predetermined reference time as the specific time, or randomly set the specific time. Further, when there is no log-in information of the user, the advertisement exposing unit 220 may set an average application use time of the users as the duration threshold based on log-in information of a plurality of users information, calculate the average number of pages consumed for the average application use time of the users and set the calculated average number of pages as the unit number of pages, and may set the specific time for exposing the advertisement based on at least one of the set duration threshold and the set unit number of pages.

In the meantime, the advertisement exposing unit 220 may further include an advertisement setting unit (not illustrated).

The advertisement setting unit may set one or more advertisements to be exposed based on at least one of the personal information about the user and information about the contents exposed in the duration threshold. For example, when the user is a woman and requested contents are information related to fashion, the advertisement setting unit may set an advertisement related to woman fashion, such as clothes, shoes, and bags, to be exposed. Accordingly, the contents providing apparatus 200 may expose an advertisement about which interest of the user is high and to which the user may concentrate, thereby maximizing an effect of the advertisement.

The advertisement setting unit may set one or more advertisements to be exposed at a specific time of a second duration threshold based on the information related to the contents exposed in the first duration threshold. For example, when the contents exposed in the first duration threshold are information related to a travel, the advertisement setting unit may set an advertisement related to a travel, such as a travel company and a package product, as an advertisement to be exposed at the specific time of the second duration threshold. In another example, the advertisement setting unit may set an advertisement related to contents having a high exposure frequency based on information related to contents exposed during a corresponding period by setting a specific period (the last one week, and the like), but the setting of the advertisement is not limited thereto.

The contents re-exposing unit 230 exposes the stopped contents through the user terminal 100 again. In this case, the contents re-exposing unit 230 may expose a corresponding stopped page of the contents based on information related to the stopped contents, which are stored when the contents are stopped, through the advertisement exposing unit 220 again.

FIG. 3 is a diagram illustrating an example for setting a specific time according to the exemplary embodiment of the present invention.

The contents providing apparatus 200 (see FIG. 2) may set a specific time based on at least one of the duration threshold and the unit number of pages based on the log-in information of the user, stop the exposed contents at the set specific time, and expose one or more advertisements.

First, terms related to the duration threshold and the unit number of pages for setting the specific time will be described. Here, it is assumed that a time has a unit of second.

As the duration threshold D, an average use time of using an application for exposing contents requested by the user (a unique value (UV)) based on the log-in information of the user may be set. For example, as the duration threshold D, an average time of a time when the application installed in the user terminal 100 is executed and stopped by the user may be set.

The unit number μ of pages may be set as the average number of pages consumed by the user for the average application use time, that is, the duration threshold D. This is expressed by Equation 1 below.

$$μ = \frac{{\sum }_{u = 1}^{UV} {\sum }_{t = 1}^{D} ( {TR}_{ut} + 1}{UV} \qquad [ Equation 1 ]$$

Here, TRᵤₜ is a variable according to a change or non-change in a page for each time t by the user, and when a page is changed for each time, a value of TRᵤₜ is 1, and when a page is not changed for each time, a value of TRᵤₜ is 0.

In the meantime, when a standard deviation σ is applied to the unit number μ of pages calculated by Equation 1, the unit number μ of pages may also be Equation 2.

$$μ = \frac{μ + ( μ - σ )}{2} \qquad [ Equation 2 ]$$

Here, μ indicates the number of pages calculated by aforementioned Equation 1, and σ indicates the standard deviation.

Next, a time for setting the specific time and the variable for the page will be defined below.

First, fᵢ is a time frame, and a length of fᵢ is the same as the duration threshold D. Here, i indicates a current time frame index, and 1≦i<∞. That is, i=1 in a first duration threshold D at which the exposure of the contents is started, so that a time frame may be sequentially increased as a first time frame is f₁, and a next time frame is f₂. For example, as illustrated in FIG. 3, the time frames f₁ to f₃ may be arranged in a form in which each of the duration thresholds D is connected according to elapse of the time.

ftᵢ is a begin time of the time frame fᵢ, and indicates a time indicating a reference at which the time frame fᵢ beings.

As illustrated in FIG. 3, vi is a relative time compared to a current time of the time frame fᵢ (relative time on fi, vᵢ=current time−ftᵢ), and nᵢ is a page index for the number of pages included in the time frame fᵢ (page index on fᵢ), and 1≦nᵢ<∞.

$$p = f ( {n}_{i} , {v}_{i} ) = \{ \begin{matrix}{n}_{i} , {v}_{i} \geq D , {y}_{i} == 0 \\ x \sim U ( [ 1 , μ ] ) , {n}_{i} = 1\end{matrix} \qquad [ Equation 3 ]$$

According to Equation 3, when vᵢ is equal to or larger than the duration threshold D in a state where a page index is nᵢ that is, when a specific page is not continuously changed in the duration threshold D, the advertisement is not exposed within the duration threshold D. In this case, the advertisement may be exposed right after the elapse of the duration threshold D. For the control of the operation, an Equation below may be applied.

$${AD}^{′} s visibility {y}_{i} = \{ \begin{matrix}1 , p == {n}_{i} \\ 0 , otherwise\end{matrix}$$

Here, yᵢ is a variable related to the exposure of an advertisement, and will be described below in connection with Equation 3.

When there is no movement of the page by the user at nᵢ (p==nᵢ) until the duration threshold D elapses, so that the advertisement is not exposed (yᵢ==0), the advertisement is exposed right after the elapse of the duration threshold D (yᵢ=1), and in other cases, the advertisement is not exposed (yᵢ=0).

That is, when there is no movement of the page by the user in the duration threshold D, the contents providing apparatus 200 may expose the advertisement by setting a time right after the elapse of the duration threshold D as the specific time.

In the meantime, referring to Equation 3 again, when the page index nᵢ is equal to or larger than 1 (ni≧1), one or more advertisements may be exposed at a specific time x within a range of the unit number of pages (1 to μ).

To summary, when the page is consumed within the duration threshold D, that is, there is the movement of the page, the contents providing apparatus 200 exposes the advertisement at a randomly set specific time, or when there is no movement of the page during the duration threshold D, the contents providing apparatus 200 exposes the advertisement right after the elapse of the duration threshold.

In the meantime, according to the exposure of the advertisement within the duration threshold D or the elapse of the duration threshold D, Equation 4 below is used in order to set the time frame fᵢ.

$$i = i + 1 , {ft}_{i} = current time , if \{ \begin{matrix}{y}_{i} = 1 , {v}_{i} < D \\ or \\ {v}_{i} \geq D\end{matrix} \qquad [ Equation 4 ]$$

According to Equation 4, when yᵢ is 1, and vᵢ is smaller than the duration threshold D or vᵢ is equal to or larger than the duration threshold D, that is, the advertisement is exposed within the duration threshold D or the duration threshold D elapses regardless of the exposure of the advertisement, i of the time frame fᵢ is i+1, and the current time is set as ftᵢ (the begin time of the time frame fᵢ). That is, when the above condition is satisfied, the time frame fᵢ beginning based on the current time may be set.

The method of setting the time frame may adopt at least one method between two methods according to an operation policy, or adopt a combination of the two methods according to a predetermined condition.

For example, when the advertisement is exposed within the duration threshold D, the time frame fᵢ in which the current time is set as ftᵢ may be set. That is, this means that in a case where the advertisement is exposed within the duration threshold D, even though the duration threshold D does not elapse, the time frame fᵢ may be set based on the current time. That is, unlikely to the illustration of FIG. 3, when the advertisement is exposed in a state where the duration threshold D does not elapse, the time frame fᵢ is newly set based on the current time, so that a length of the time frame fᵢ may be changed according to the specific time at which the advertisement is exposed. In this case, a plurality of times of specific time may be set within the duration threshold.

In another example, when the duration threshold D elapses regardless of the exposure of the advertisement, the time frame fᵢ in which the current time is set as ftᵢ may be set. That is, as illustrated in FIG. 3, time frames having a predetermined time interval according to the duration threshold D may be enumerated. In this case, the number of times of specific time may be one or smaller within the duration threshold.

FIG. 3 illustrates the case where the unit number of pages for a plurality of duration thresholds D is 4.

FIG. 3 illustrates the case where the time frame fᵢ is set with a predetermined time interval according to the duration threshold D regardless of the exposure of the advertisement, but is not limited thereto.

As described above, the length of the time frame fᵢ is the same as the D, and i indicates a time frame index.

Hereinafter, for convenience of the description, f₁ is indicated as a first time frame (or a first duration threshold) when i=1, f₂ is indicated as a second time frame (or a second duration threshold) when i=2, and f₃ is indicated as a third time frame (or a third duration threshold) when i=3.

As illustrated in FIG. 3, the time frames fᵢ are classified according to the duration threshold D, and each of the time frames fᵢ includes four unit pages. Further, the page index of the pages included in each time frame may be indicated with n₁, n₂, n₃, and n₄.

In this case, the specific time may be randomly set within the first to third time frames, and the advertisement may be exposed within the range (one to four) in which the unit number of pages within the first time frame does not exceed four. For example, the advertisement may be exposed at n₂ in the first time frame, and the advertisement may be exposed at n₃ in the second time frame.

In the meantime, when the user continuously stays at a certain page without moving the page within the first time frame, for example, when the page is not changed in the state where the page index is n₁, so that the advertisement is not exposed within the first time frame, the page index is n₁, so that the advertisement may be immediately exposed in the second time frame beginning after the first time frame. For example, the contents providing apparatus 200 may immediately expose the advertisement at ft₂ (a beginning time of the second time frame).

When one or more advertisements include order information, and a number of specific times, at which the one or more advertisements are exposed, is plural, the contents providing apparatus 200 may make each of the exposed advertisements be sequentially exposed according to the order information.

When the advertisement is a series advertisement for improving an effect of the advertisement through continuous exposure, the advertisements may be sequentially exposed at each of the specific times according to an order of the series advertisements. For example, an advertisement having the first order may be exposed at n₂ at a first specific time set within the first time frame, and an advertisement having the second order may be exposed at n₃ at a second specific time set within the second time frame. Here, the series advertisements mean advertisements continuously and sequentially posted for a predetermined time for one subject or product.

As described above, when the related advertisements are sequentially exposed by the contents providing apparatus 200, expected mind of the user may be increased, and the effect of the advertisement may be further improved.

The contents providing apparatus 200 according to the exemplary embodiment of the present invention may expose an advertisement at an appropriate time zone during the use of the contents by the method using temporal division so that contents and an advertisement may use a screen, on which the contents are exposed, thereby improving an effect of the advertisement. That is, the present invention stops the contents at a specific time (for example, a time zone at which attention of the users is expected to be decreased, or a time zone at which users have high concentration) set based on the log-in information of the user for a short while, and makes the advertisement be exposed, thereby improving interest and concentration of the user.

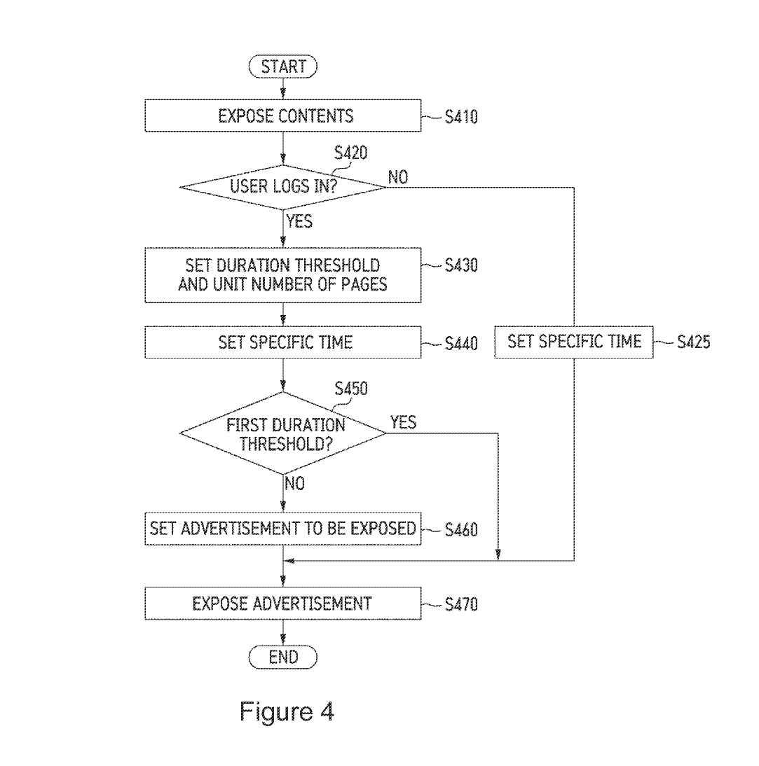

FIG. 4 is a flowchart illustrating a contents and advertisement providing method according to an exemplary embodiment of the present invention.

Referring to FIG. 4, the contents providing apparatus 200 (see FIG. 2) exposes contents requested by a user through the user terminal 100 (see FIG. 1) (S410).

The contents providing apparatus 200 determines whether the user logs in (S420).

When the user does not log in as a result of the determination, the contents providing apparatus 200 may set a predetermined reference time as a specific time, or randomly set a specific time (S425).

On the other hand, when the user logs in, the contents providing apparatus 200 sets a duration threshold and the unit number of pages based on the log-in information of the user (S430). That is, the contents providing apparatus 200 may set an average application use time of the user calculated based on the log-in information of the user as the duration threshold, and set the average number of pages consumed for the average use time calculated based on the log-in information of the user as the unit number of pages.

Then, the contents providing apparatus 200 may set a specific time based on at least one of the set duration threshold and the set unit number of pages (S440). In this case, the contents providing apparatus 200 randomly sets the specific time within the duration threshold, and sets one or more advertisements to be exposed within a range of the unit number of pages. Further, when a movement of the page by the user is not generated during the duration threshold, the contents providing apparatus 200 may also set a time right after elapse of the duration threshold as the specific time.

Next, the contents providing apparatus 200 determines whether a current time is included in a first duration threshold (or the first time frame, see FIG. 3) which is the first beginning duration threshold (S450).

When the current time is not included in the first duration threshold as a result of the determination, that is, there is a duration threshold in which contents are previously consumed, the contents providing apparatus 200 sets one or more advertisements to be exposed (S460). In this case, the contents providing apparatus 200 may set one or more advertisements to be exposed based on at least one of personal information about the user and information about the contents exposed in the duration threshold. The contents providing apparatus 200 may set the advertisement related to the contents exposed in the previous duration threshold to be exposed, but is not limited thereto. For example, the contents providing apparatus 200 may set one or more advertisements to be exposed at a specific time set in a second duration threshold based on the information related to the contents exposed in the first duration threshold.

The contents providing apparatus 200 stops the contents exposed and exposes the advertisement at the previously set specific time (S470). In this case, the contents providing apparatus 200 may expose a corresponding page of the stopped contents again.

On the other hand, when the current time is included in the first duration threshold, the contents providing apparatus 200 omits a process of setting the advertisement to be exposed (S460), and exposes one or more advertisements at the set specific time (S470).

In the meantime, processes S450 and S460 of setting the advertisement by determining whether the current time is included in the first duration threshold may be omitted.

The above description of the present invention is illustrative, and those skilled in the art to which the present invention pertains may understand that modifications to other particular forms may be easily made without changing the technical spirit or the essential feature of the present invention. Thus, it is to be appreciated that embodiments described above are intended to be illustrative in every sense, and not restrictive. For example, each constituent element described in a singular form may be distributed and performed, and similarly, constituent elements described in a distributed form may be performed in a combination form.

The scope of the present invention is represented by the claims to be described below, and it is to be interpreted that the meaning and scope of the claims and all the changes or modified forms derived from the equivalents thereof belong to the scope of the present invention.

What is claimed is:

1. A method of providing an advertisement and contents requested by a user through an application by a contents providing apparatus, the method comprising:
exposing the contents through a user terminal;
stopping the exposed contents at a specific time set based on log-in information of the user, and exposing one or more advertisements; and
exposing the stopped contents through the user terminal again.

2. The method of claim 1, wherein the exposing of the one or more advertisements includes:
calculating an average application use time of the user based on the log-in information, and setting the calculated average use time as a duration threshold;
calculating the average number of pages consumed for the average use time based on the log-in information, and setting the calculated average number of pages as a unit number of pages; and
setting the specific time based on at least one of the duration threshold and the unit number of pages.

3. The method of claim 2, wherein the exposing of the one or more advertisements includes randomly setting the specific time within the duration threshold, and exposing the one or more advertisements within a range of the unit number of pages.

4. The method of claim 3, wherein the setting of the specific time includes setting as the specific time a time right after elapse of the duration threshold, when there is no movement of a page by the user in the duration threshold.

5. The method of claim 2, wherein the exposing of the one or more advertisements includes setting the one or more advertisements to be exposed based on at least one of personal information about the user and information related to the contents exposed in the duration threshold.

6. The method of claim 5, wherein the exposing of the one or more advertisements includes setting one or more advertisements to be exposed at a specific time set in a second duration threshold based on information related to contents exposed in a first duration threshold.

7. The method of claim 1, wherein the exposing of the one or more advertisements includes setting a predetermined reference time as the specific time or randomly setting the specific time, when the user does not log in.

8. The method of claim 1, wherein the exposing of the one or more advertisements includes sequentially exposing each of the exposed advertisements according to order information, when the one or more advertisements include order information, and a number of the specific times at which the one or more advertisements are exposed is plural.

9. A contents providing apparatus for providing an advertisement and contents requested by a user through an application, the apparatus comprising:
a contents exposing unit configured to expose exposing the contents through a user terminal;
an advertisement exposing unit configured to stop the exposed contents at a specific time set based on log-in information of the user, and expose one or more advertisements; and
a contents re-exposing unit configured to expose the stopped contents through the user terminal again.

10. The contents providing apparatus of claim 9, wherein the advertisement exposing unit
sets as a duration threshold an average application use time of the user calculated based on the log-in information, calculates an average number of pages consumed for the average use time and sets the calculated average number of pages as the unit number of pages, and
sets the specific time based on at least one of the duration threshold and the unit number of pages.

11. The contents providing apparatus of claim 10, wherein the advertisement exposing unit randomly sets the specific time within the duration threshold, and exposes the one or more advertisements within a range of the unit number of pages.

12. The contents providing apparatus of claim 11, wherein the advertisement exposing unit sets as the specific time a time right after elapse of the duration threshold, when there is no movement of a page by the user in the duration threshold.

13. The contents providing apparatus of claim 10, wherein the advertisement exposing unit further includes an advertisement setting unit configured to set the one or more advertisements to be exposed based on at least one of personal information about the user and information related to the contents exposed in the duration threshold.

14. The contents providing apparatus of claim 13, wherein the advertisement setting unit sets one or more advertisements to be exposed at a specific time set in a second duration threshold based on information related to contents exposed in a first duration threshold.

15. The contents providing apparatus of claim 9, wherein the advertisement exposing unit sets a predetermined reference time as the specific time or randomly sets the specific time, when the user does not log in.

16. The contents providing apparatus of claim 9, wherein the advertisement exposing unit sequentially exposes each of the exposed advertisements according to order information, when the one or more advertisements include order information, and a number of specific times, at which the one or more advertisements are exposed, is plural.
